(19) United States
(12) Patent Application Publication
(10) Pub. No.: US 2019/0278468 A1
(43) Pub. Date: Sep. 12, 2019

(54) ELECTRONIC APPARATUS, DISPLAY DEVICE, AND METHOD OF CONTROLLING ELECTRONIC APPARATUS

(71) Applicant: SEIKO EPSON CORPORATION, Tokyo (JP)

(72) Inventors: Mitsunori TOMONO, Suwa-gun (JP); Toshiki FUJIMORI, Chino-shi (JP)

(73) Assignee: SEIKO EPSON CORPORATION, Tokyo (JP)

(21) Appl. No.: 16/296,652

(22) Filed: Mar. 8, 2019

(30) Foreign Application Priority Data
Mar. 9, 2018 (JP) 2018-042574

(51) Int. Cl. G06F 3/0484; G09G 5/00; G06K 7/10

(52) U.S. Cl. CPC G06F 3/04847; G09G 5/006; G06K 7/10297; G09G 3/001; G09G 2370/06; G09G 2320/0606; G09G 2354/00; G06K 7/10316

(57) ABSTRACT

A terminal device is provided with a display panel, a touch sensor, a display control section adapted to make the display panel display a user interface for performing setting of a projector in accordance with a type of the projector, a configuration information processing section adapted to edit UI configuration data based on an input corresponding to the user interface, and an NFC tag storing the UI configuration data edited so as to be able to be read by the projector.

### CROSS-REFERENCE

The entire disclosure of Japanese Patent Application No. 2018-042574, filed on Mar. 9, 2018 is expressly incorporated by reference herein.

### BACKGROUND

### 1. Technical Field

The present invention relates to an electronic apparatus, a display device, a display system, a method of controlling an electronic apparatus, a method of controlling a display device, and a program.

### 2. Related Art

In the past, there has been disclosed a system in which a display device and a terminal device are connected to each other to perform setup of the display device in accordance with configuration information in the terminal device (see, e.g., JP-A-2014-170032 (Document 1)). The system in Document sets the configuration information corresponding to identification information of the terminal device to the display device to thereby make the setting by a different terminal device possible.

Functions and operations of display devices differ between models. Therefore, in the case of applying the related art technology described above to a plurality of models of display devices, it is conceivable that the terminal device provides the display device with the configuration information different by the model of the display device. In this case, it is necessary to select the configuration information corresponding to the model of the display device by an operation of the terminal device, and to take care of the configuration information, and it is conceivable that the operation of the terminal device becomes cumbersome.

### SUMMARY

An advantage of some aspects of the invention is to reduce the burden related to the operation of a terminal device in the case of performing setup of a display device using the terminal device.

An electronic apparatus according to an aspect of the invention includes a display section, an input section adapted to receive an input, a communication section adapted to communicate with a display device, a configuration information processing section adapted to identify a type of the display device having communication with the communication section, make the display section display a user interface used to perform setting of the display device in accordance with the identified type of the display device, and edit configuration information related to the setting of the display device based on the input received in a case in which the input corresponding to the user interface is received by the input section, and a storage section adapted to store the configuration information edited by the configuration information processing section so as to be able to be read by the display device.

According to the aspect of the invention, the electronic apparatus displays the user interface in accordance with the type of the display device, and it is possible to edit the configuration information related to the setting of the display device using the user interface. Thus, it is possible to simplify the operation of editing the configuration information in accordance with the model of the display device to thereby reduce the burden on the user.

The aspect of the invention may be configured such that, subject to reception by the communication section of request data requesting the configuration information with the type of the display device designated, the configuration information processing section makes the display section display the user interface corresponding to the type of the display device designated by the request data.

According to this configuration, since the user interface is displayed in response to the electronic apparatus receiving the request data, it is possible to simplify the operation for displaying the user interface corresponding to the type of the display device.

The aspect of the invention may be configured such that the configuration information includes type information representing the type of the display device and information related to the setting of the display device associated with each other.

According to this configuration, since the type of the display device and the setting of the display device are associated with each other in the configuration information, the burden required for the management of the configuration information can be reduced.

The aspect of the invention may be configured such that the configuration information includes information for designating setting target items to be displayed and information for designating an arrangement of each of the setting target items with respect to the user interface to be displayed by the display device for setting related to an operation of the display device.

According to this configuration, it is possible to set the setting target items and the arrangement thereof to be displayed in the user interface of the display device with a simple operation using the electronic apparatus making the communication with the display device.

Another aspect of the invention is directed to a display device equipped with a display section, including an input section adapted to receive an input, a setting control section adapted to make the display section display a user interface having setting target items arranged, determine a setting value to each of the setting target items based on the input received by the input section, and then set a function of the display device in accordance with the setting value determined, and an acquisition section adapted to obtain configuration information defining a configuration of the user interface from an external recording medium, wherein the setting control section configures the user interface in accordance with the configuration information obtained by the acquisition section, and then makes the display section display the user interface.

According to the aspect of the invention, the user interface of the display device can be configured in accordance with the configuration information obtained from the external recording medium. Therefore, the setting related to the user interface of the display device can easily be achieved using the electronic apparatus providing the configuration information recorded on the recording medium.

The aspect of the invention may be configured such that the acquisition section transmits request data requesting the configuration information with a type of the display device designated to an electronic apparatus corresponding to the external recording medium in a case in which the configuration information corresponding to the type of the display device is absent in the external recording medium.

According to this configuration, it is possible for the display device to request the configuration information corresponding to the type of the display device to the electronic apparatus. Therefore, it is not necessary for the display device to manage the correspondence between the type of the display device and the configuration information, and it is possible to reduce the burden related to the management.

Another aspect of the invention is directed to a display system including a display device and an electronic apparatus configured as a separate body from the display device, wherein the electronic apparatus includes a first display section, a first input section adapted to receive an input, a communication section adapted to communicate with the display device, a configuration information processing section adapted to identify a type of the display device having communication with the communication section, make the first display section display a user interface used to perform setting of the display device in accordance with the identified type of the display device, and edit configuration information related to setting of the display device based on the input received in a case in which the input corresponding to the user interface is received by the first input section, and a storage section adapted to store the configuration information edited by the configuration information processing section so as to be able to be read by the display device, the display device includes a second display section, a second input section adapted to receive an input, a setting control section adapted to make the second display section display a user interface having setting target items arranged, determine a setting value to each of the setting target items based on the input received by the second input section, and then set a function of the display device in accordance with the setting value determined, and an acquisition section adapted to read the configuration information from the storage section provided to the electronic apparatus, and the setting control section configures the user interface in accordance with the configuration information obtained by the acquisition section, and then makes the second display section display the user interface.

According to the aspect of the invention, since it is possible to configure the user interface of the display device in accordance with the configuration information stored in the storage section by the electronic apparatus, it is possible to easily achieve the setting related to the user interface of the display device using the electronic apparatus. Further, the electronic apparatus displays the user interface in accordance with the type of the display device, and it is possible to edit the configuration information related to the setting of the display device using the user interface. Therefore, it is possible to simplify the operation of editing the configuration information in accordance with the model of the display device to thereby reduce the burden on the user.

The aspect of the invention may be configured such that the electronic apparatus stores the configuration information including type information representing the type of the display device and information related to the setting of the display device associated with each other in the storage section, the display device transmits request data requesting the configuration information with the type of the display device designated to the electronic apparatus using the acquisition section in a case in which the configuration information corresponding to the type of the display device is absent in the storage section, and the electronic apparatus displays the user interface corresponding to the type of the display device designated by the request data in the first display section in a case in which the communication section has received the request data transmitted by the display device.

According to this configuration, since it is possible for the display device to request the configuration information corresponding to the type of the display device to the electronic apparatus, it is possible to reduce the burden of managing the correspondence between the type of the display device and the configuration information.

Another aspect of the invention is directed to a program executable by a computer having a display section, an input section adapted to receive an input and a communication section adapted to communicate with a display device, the program making the computer operate as a configuration information processing section that identifies a type of the display device having communication with the communication section, make the display section display a user interface used to perform setting of the display device in accordance with the identified type of the display device, edit configuration information related to the setting of the display device based on the input received in a case in which the input corresponding to the user interface is received by the input section, and make a storage section store the edited configuration information so as to be able to be read by the display device.

The computer executing the program according to the aspect of the invention causes the user interface to be displayed in accordance with the type of the display device, and it is possible for the user to edit the configuration information related to the setting of the display device using the user interface displayed. Thus, it is possible to simplify the operation of editing the configuration information in accordance with the model of the display device to thereby reduce the burden on the user.

Another aspect of the invention is directed to a method of controlling an electronic apparatus including communicating with a display device using a communication section, identifying a type of the display device to be communicated with, displaying a user interface used to perform setting of the display device in a display section in accordance with the identified type of the display device, receiving an input corresponding to the user interface using an input section, editing configuration information related to the setting of the display device based on the input received, and storing the edited configuration information in a storage section so as to be able to be read by the display device.

According to the aspect of the invention, the electronic apparatus displays the user interface in accordance with the type of the display device, and it is possible to edit the configuration information related to the setting of the display device using the user interface. Thus, it is possible to simplify the operation of editing the configuration information in accordance with the model of the display device to thereby reduce the burden on the user.

Another aspect of the invention is directed to a method of controlling a display device including displaying a user interface having setting target items arranged using a display section, receiving an input using an input section, determining a setting value to each of the setting target items based on the input received and then setting a function of the display device in accordance with the setting value determined, obtaining configuration information defining a configuration of the user interface from an external recording medium, and configuring the user interface in accordance with the configuration information obtained, and then displaying the user interface using the display section.

According to the aspect of the invention, the user interface of the display device can be configured in accordance with the configuration information obtained from the external recording medium. Therefore, the setting related to the user interface of the display device can easily be achieved using the electronic apparatus providing the configuration information recorded on the recording medium.

The invention can be implemented in a variety of forms other than the electronic apparatus, the display device, the display system, the method of controlling the electronic apparatus, the method of controlling the display device, and the program described above. For example, the invention can be implemented as a recording medium storing the program described above, a server for delivering the program, a transmission medium for transmitting the program described above, and a data signal including the computer program described above and embodied in a carrier wave.

### BRIEF DESCRIPTION OF THE DRAWINGS

The invention will be described with reference to the accompanying drawings, wherein like numbers reference like elements.

FIG. 1 is a diagram showing a schematic configuration of a display system according to the embodiment.

FIG. 2 is a block diagram of a projector.

FIG. 3 is a diagram showing a configuration example of a user interface of the projector.

FIG. 4 is a diagram showing a configuration example of UI data of the projector.

FIG. 5 is a block diagram of a terminal device.

FIG. 6 is a diagram showing a configuration example of UI configuration data of the terminal device.

FIG. 7 is a diagram showing a configuration example of a user interface of the terminal device.

FIG. 8 is a flowchart showing an operation of the projector.

FIG. 9 is a flowchart showing an operation of the terminal device.

### DESCRIPTION OF EXEMPLARY EMBODIMENTS

### 1. Configuration of Display System

A display system 1 according to an embodiment to which the invention is applied will hereinafter be described with reference to the drawings.

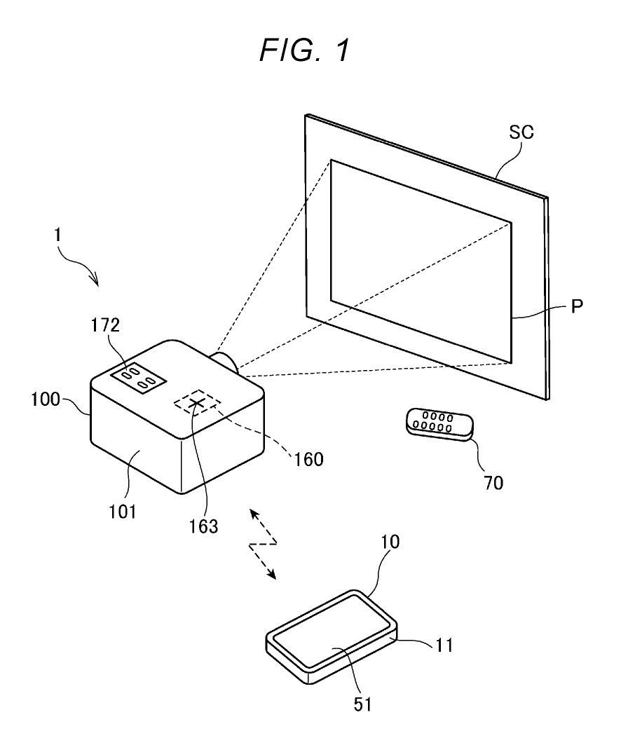

FIG. 1 is a diagram showing a schematic configuration of the display system 1. The display system 1 is provided with an electronic apparatus, and a projector 100 as a display device. In the present embodiment, a terminal device 10 of a portable type is illustrated as the electronic apparatus. With respect to the projector 100, the terminal device 10 is an external device configured as a separate body from the projector 100, and therefore, the projector 100 is an external display device for the terminal device 10. FIG. 1 is a configuration example of the display system 1, and the number of the projectors 100 and the terminal devices 10 provided to the display system 1, and the number of the terminal devices 10 communicated with the projector 100 are not particularly limited.

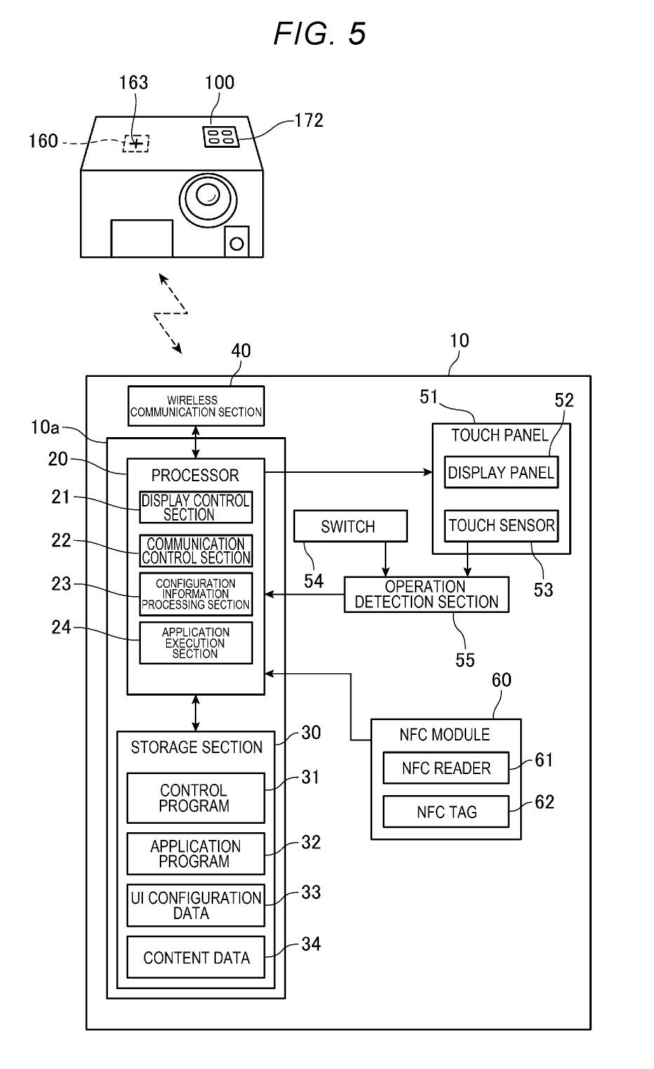

The electronic apparatus provided to the display system 1 is, for example, a smartphone, a portable phone, or a portable computer such as a tablet computer or a laptop computer. The terminal device 10 is a tablet computer having a terminal device main body 11 shaped like a flat plate, and a touch panel 51 disposed on a surface of the terminal device main body 11. The touch panel 51 is provided with a touch sensor 53 (FIG. 5) for detecting a contact operation by the user.

The projector 100 projects image light to a screen SC to thereby form a projection image P on the screen SC. As the screen SC, it is possible to use a fixed plane such as a wall surface, a plane such as a blackboard attached to the wall surface, or a curtain-like screen of a suspended type or a rising type.

On the upper surface of a projector main body 101, there is disposed an operation panel 172. The operation panel 172 is provided with switches for the user to operate the projector 100. For example, the operation panel 172 is provided with a power switch and a setting menu switch. The operation panel 172 is provided with indicator lamps for indicating the operation state of the projector 100.

The projector 100 can be operated using a remote controller 70 for transmitting an infrared signal. The remote controller 70 is provided with a variety of switches for operating the projector 100, and transmits a signal corresponding to the operation of the switch to the projector 100 as the infrared signal. The remote controller 70 is provided with, for example, a power switch and a setting menu switch.

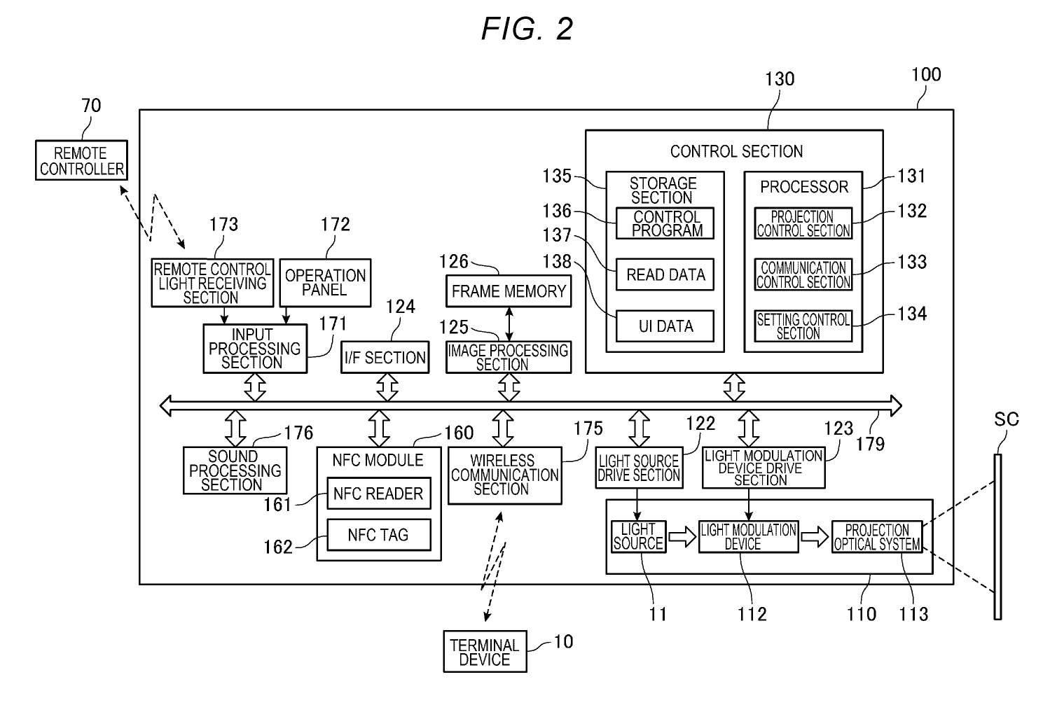

The projector 100 is provided with an NFC (near field communication) module 160. As described later with reference to FIG. 2, the NFC module 160 is provided with an NFC reader 161 for performing reading and writing of an NFC tag, and an NFC tag 162. It is possible for the projector 100 to perform reading of data from and writing of data to an external NFC tag using the NFC module 160. On the upper surface of the projector main body 101, there is attached a marker 163 which is an index of a position where the NFC module 160 can communicate with the NFC tag.

In the display system 1, there are used the NFC tag 162 and an NFC tag 62 (FIG. 5), and the NFC reader 161 and an NFC reader 61 (FIG. 5) as NFC reader/writer for performing reading from and writing to the NFC tag.

As the NFC readers 61, 161 and the NFC tags 62, 162, it is possible to use those compliant with, for example, the standard of NFC laid down by ISO, or a variety of RFID standards such as Felica (registered trademark). As an RFID tag, there are known a tag using a wireless signal in the 125 kHz band, a tag using a wireless signal in the 13.56 MHz band, a tag using a wireless signal in the UHF band (the 950 MHz band), a tag using a wireless signal in the 2.45 GHz band, and so on. The NFC tags 62, 162 can be any one of these tags. Further, it is sufficient for the NFC readers 61, 161 to be capable of performing reading from and writing to the NFC tags 62, 162. It is also possible for the display system 1 to have a configuration provided with the NFC readers 61, 161 and the NFC tags 62, 162 using a wireless signal in, for example, the 13.56 MHz band rich in installation example to smartphones or the like.

The terminal device 10 is provided with the NFC tag 62 (FIG. 5) as described later. The NFC module 160 is capable of performing reading data from and writing data to the NFC tag 62 of the terminal device 10. Therefore, the terminal device 10 and the projector 100 are capable of performing data communication using NFC.

Further, the terminal device 10 and the projector 100 are connected to each other so as to be able to transmit and receive a variety of types of data with a wireless communication system other than NFC. There can be cited near field communication systems such as wireless LAN (local area network), Bluetooth (registered trademark) and UWB (ultra wide band). The wireless LAN includes Wi-Fi (registered trademark).

### 2. Configuration of Projector

FIG. 2 is a block diagram showing a configuration of the projector 100.

The projector 100 is provided with a control section 130 for controlling each section of the projector 100, and a projection section 110 for projecting the projection image P. The control section 130 is constituted by a processor 131, a storage section 135 and so on. The storage section 135 is a storage device for storing a control program executed by the processor 131 and data in a nonvolatile manner, and is constituted by a semiconductor storage element or the like such as a flash ROM. The storage section 135 can also include a RAM constituting the work area for the processor 131. The processor 131 can be constituted by a single processor, or it is also possible to adopt a configuration in which a plurality of processors functions as the processor 131.

The processor 131 is constituted by an arithmetic processing device such as a CPU (central processing unit) or a microcomputer. The processor 131 executes a control program 136 stored in the storage section 135 to thereby function as a projection control section 132, a communication control section 133 and a setting control section 134. In other words, by the processor 131 executing the control program 136, these functional blocks are realized due to the cooperation between software and hardware.

The storage section 135 stores read data 137 and UI (user interface) data 138 in addition to the control program 136. The read data 137 is data read by the NFC reader 161 from an external NFC tag. The UI data 138 is data to be looked up when the setting control section 134 projects a menu screen, and includes information related to the items to be disposed in the menu screen.

The projection section 110 (a display section, a second display section) is provided with a light source 111, a light modulation device 112 and a projection optical system 113. The light source 111 is constituted by a lamp such as a halogen lamp, a xenon lamp or a super-high pressure mercury lamp, or a solid-state light source such as an LED or a laser source. The light source 111 is put on by the electrical power supplied from a light source drive section 122, and emits light toward the light modulation device 112.

The light source drive section 122 supplies the light source 111 with a drive current or a pulse with the control by the control section 130 to make the light source 111 emit the light.

The light modulation device 112 is provided with a light modulation element not shown such as a transmissive liquid crystal panel, a reflective liquid crystal panel or a digital mirror device (DMD). The light modulation device 112 is driven by a light modulation device drive section 123 to form an image using the light modulation element, then modulates the light emitted by the light source 111 to generate image light, and then projects the image light toward the projection optical system 113.

The light modulation device drive section 123 drives the light modulation device 112 in accordance with the image signal input from an image processing section 125 to draw the image on the light modulation element frame by frame.

The projection optical system 113 is provided with an optical element such as a lens or a mirror, and images the light modulated by the light modulation device 112 on the screen SC to project the projection image P.

Further, the projector 1 is provided with an interface (I/F) section 124, the image processing section 125, a frame memory 126, the NFC module 160, an input processing section 171, the operation panel 172, a remote control light receiving section 173, a wireless communication section 175 and a sound processing section 176. These sections are connected to the control section 130 via a bus 179 so as to be able to perform data communication.

The interface section 124, the NFC module 160, and the wireless communication section 175 are an interface to be connected to an external device. These constituents correspond to a communication section according to the invention, and can also be referred to as a connection section in another expression.

The interface section 124 is a wired interface for the data communication, and is provided with a connector, an interface circuit, and so on not shown. The interface section 124 is connected to the external device via a cable, and transmits and receives digital image data, control data and so on to and from the external device. As the interface section 124, there can be adopted a LAN interface or a USB interface. Further, the interface section 124 can also be an image interface to be connected to an image supply device. In this case, for example, the interface section 124 is constituted by HDMI (registered trademark) or a D-Sub interface. HDMI is an abbreviation of high definition multimedia interface. The projector 100 projects an image with the projection section 110 based on the image data input from the image supply device connected to the interface section 124.

The wireless communication section 175 is provided with an antenna, an RF circuit, and so on not shown, and performs the wireless data communication with an external device in accordance with the control by the control section 130. The wireless communication section 175 performs the wireless communication such as wireless LAN or Bluetooth.

To the light modulation device drive section 123, there is input an image signal of an image to be drawn in the light modulation device 112 from the image processing section 125. The light modulation device drive section 123 drives the light modulation device 112 based on the image signal output by the image processing section 125.

The image processing section 125 is connected to the frame memory 126. The image processing section 125 develops an image based on the image data selected as an image source on the frame memory 126. The image source is selected from the image data received by the interface section 124 or the wireless communication section 175, content data stored by the storage section 135, or the like.

The image processing section 125 performs a variety of types of image processing on the image developed on the frame memory 126. The image processing section 125 generates the image signal for displaying the image developed on the frame memory 126, and then outputs the image signal to the light modulation device drive section 123.

Further, the image processing section 125 has an OSD (on-screen display) processing function. Due to the OSD processing function, the image processing section 125 superimposes another image on the image developed on the frame memory 126 based on the image data to thereby combine the images with each other, and then outputs the composite image to the light modulation device drive section 123. For example, in the case in which the setting menu switch of the operation panel 172 or the remote controller 70 is operated, the image processing section 125 displays the menu screen for performing setting related to the functions of the projector 100 using the OSD processing function. The menu screen is projected by the projection section 110 so as to be superimposed on the image developed on the frame memory 126 based on the image data. In this case, the projection image P becomes an image having the menu screen superimposed on the image based on the image data.

The input processing section 171 (an input section, a second input section) is connected to the operation panel 172 and the remote control light receiving section 173. In the case in which the operation panel 172 or the remote control light receiving section 173 has received the operation, the input processing section 171 generates operation data corresponding to the operation thus received, and then outputs the operation data thus generated to the control section 130. The remote control light receiving section 173 receives an infrared signal transmitted by the remote controller 47. The input processing section 171 decodes the signal received by the remote control light receiving section 173 to generate the operation data, and then outputs the operation data to the control section 130.

The sound processing section 176 processes sound data in accordance with the control by the control section 130. The sound processing section 176 outputs the sound based on the sound data from a speaker provided to the projector 100 and an external speaker.

The projector 100 is provided with the NFC module 160. The NFC module 160 has the NFC tag 162 and the NFC reader 161.

The NFC module 160 is disposed in the vicinity of the marker 163 inside the projector main body 101 (FIG. 1).

The NFC reader 161 (an acquisition section) is a reader/writer of the NFC tag provided with an antenna, a transmission circuit, a reception circuit and so on not shown. The NFC reader 161 performs communication with an external NFC tag having approached within a predetermined distance from the marker 163 to perform acquisition of data recorded on the NFC tag and writing of data to the NFC tag. The NFC reader 161 is capable of performing reading of data from, and writing of data to the NFC tag 62 (FIG. 5) described later.

The NFC tag 162 has a rewritable storage area for storing data in a nonvolatile manner. Reading of data from the storage area of the NFC tag 162, and writing of data to the storage area of the NFC tag 162 can be performed by an external NFC reader/writer having approached the marker 163. Further, to the storage area of the NFC tag 162, it is possible to write data using the control section 130 or the NFC reader 161. The NFC tag 162 can be an active tag supplied with the power from a power supply circuit of the projector 100, or can also be a passive tag supplied with the power from an external device which reads the NFC tag 162.

The projection control section 132 controls the light source drive section 122, the light modulation device drive section 123 and the image processing section 125 to make the projection section 110 project the projection image P based on the image data selected as the image source.

The communication control section 133 controls the wireless communication section 175 to perform the wireless communication with the terminal device 10. The communication control section 133 establishes the wireless communication with the terminal device 10 to receive the control data and the content data transmitted by the terminal device 10, and then processes the data thus received.

Further, the communication control section 133 controls the data communication by the NFC module 160. The communication control section 133 controls the NFC reader 161 to perform reading of data from, and/or writing of data to the external NFC tag. The data read by the NFC reader 161 is stored in the storage section 135 as the read data 137.

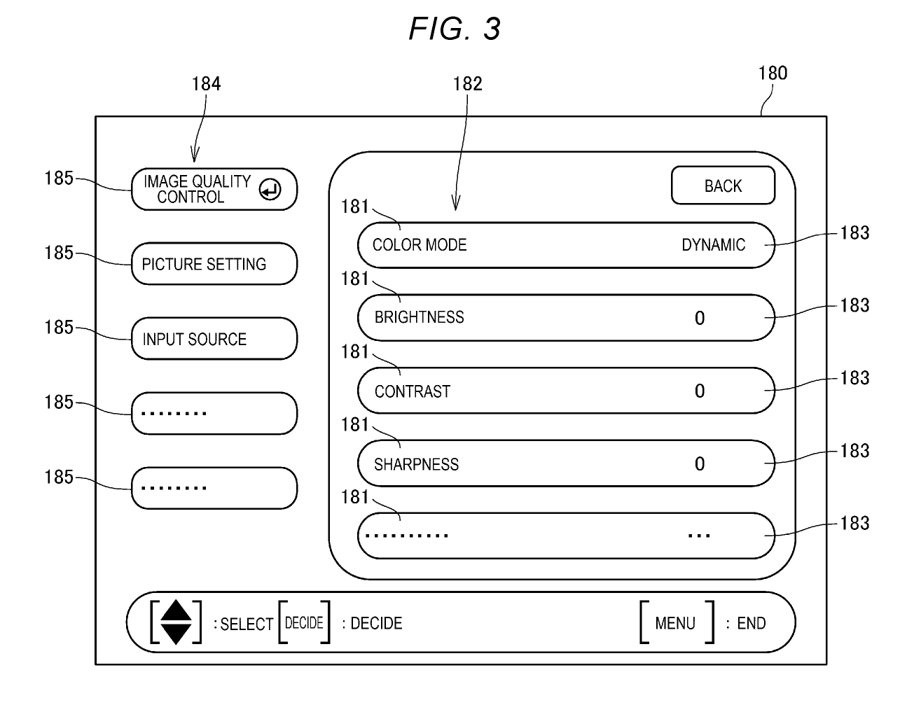

The setting control section 134 constitutes a user interface for setting used for performing setting of the projector 100 in accordance with the operation of the setting menu switch of the remote controller 70 or the operation panel 172, and then makes the projection section 110 project the user interface for setting. The user interface for setting is, for example, a menu screen 180 described later with reference to FIG. 3. The setting control section 134 determines the layout of the menu screen 180 in accordance with the UI data 138. The layout of the menu screen 180 includes items to be displayed in the menu screen 180, and an indication sequence of the items. The setting control section 134 configures the menu screen 180 in accordance with the layout thus determined, then generates display data for displaying the menu screen 180, and then makes the image processing section 125 perform the OSD process. Thus, the projection image P having the menu screen 180 superimposed using the OSD is projected. The setting control section 134 detects the operation performed on the remote controller 70 or the operation panel 172 while projecting the menu screen 180 based on the operation data input from the input processing section 171. The setting control section 134 performs the setting related to functions of the projector 100 in accordance with the operation content thus detected.

Further, the setting control section 134 rewrites the UI data 138 based on the read data 137 stored in the storage section 135.

### 3. Configuration of Menu Screen of Projector

FIG. 3 is a diagram showing an example of the menu screen 180 of the projector 100.

The menu screen 180 is an image projected on the screen SC by the OSD processing function of the image processing section 125, and includes a variety of items for performing setting related to the functions of the projector 100. The menu screen 180 is configured based on the UI data 138 stored by the storage section 135.

The menu screen 180 has an item display section 182 where a plurality of setting target items 181 is disposed so as to be able to be read through. The setting target items are each an item to which a setting value for determining the function of the projector 100 is set, and in the example shown in FIG. 3, the setting target items 181 such as a color mode, brightness, contrast, and sharpness are disposed side by side in the item display section 182.

It is possible to designate the setting value to each of the setting target items 181 by the operation of the user. In the menu screen 180, there are disposed setting value input sections 183 for selectively inputting the setting values so as to correspond respectively to the setting target items 181. The setting value input sections 183 are each formed of, for example, a pull-down menu or an input box, and it is possible for the user to selector input the setting value. For example, regarding the color mode out of the setting target items 181, it is possible to select to designate any one of three setting values of dynamic, cinema, and natural. The operation to the menu screen 180 is performed using direction keys of the operation panel 172 or direction keys of the remote controller 70.

In the item display section 182, there is disposed the plurality of setting target items 181 grouped by the setting contents or the names of the setting items. In the case in which the number of settable items for the functions of the projector 100 is large, display of the item display section 182 can be switched. In the menu screen 180, there is disposed a large classification item selection section 184 in order to select the setting target items 181 to be displayed in the item display section 182. In the large classification item selection section 184, there is disposed a plurality of large classification items 185 which can be selected so as to be able to be read through. The large classification items 185 are each a name of a group of collecting the plurality of setting target items 181, and when any one of the large classification items 185 in the large classification item selection section 184 is selected by the user, the setting target items 181 included in the large classification item 185 thus selected are displayed in the item display section 182. Thus, it is possible to switch the large classification items 185 to set the setting values to the setting target items 181.

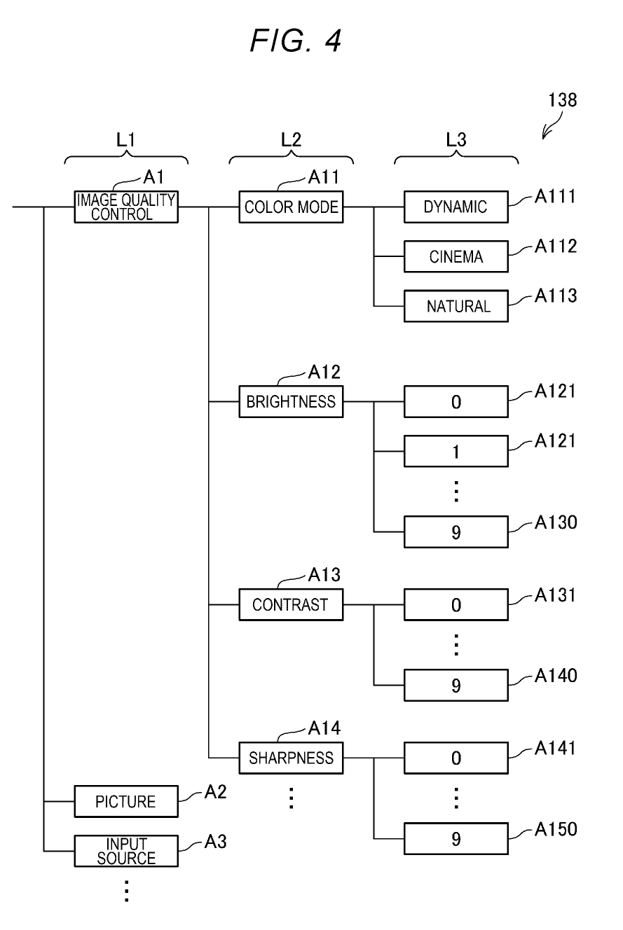

FIG. 4 is a diagram showing a configuration example of the UI data 138. The UI data 138 is data for defining the configuration of the menu screen 180, and is constituted by a hierarchical structure including a first layer L1 including the large classification items 185, a second layer L2 including the setting target items 181, and a third layer L3 including setting values to be set to the setting target items 181. The first layer L1 of the UI data 138 includes the large classification items. The UI data 138 includes the items included in each of the large classification items in the second layer L2, and further, the setting values associated with each of the items are included in the third layer L3. The configuration shown in FIG. 4 is illustrative only, and the number and the contents of the large classification items and the number and the contents of the items included in the large classification items are arbitrary.

The first layer L1 includes a plurality of large classification items A1, A2, A3, . . . , and the second layer L2 includes items A11, A12, A13, A14, . . . associated with each of the large classification items A1, A2, A3, . . . in the example shown in FIG. 4. Further, the setting values associated with each of the items A11, A12, A13, A14, . . . are included in the third layer L3. The large classification item A1 includes the items related to image quality control, and specifically includes the item A11 related to the color mode, the item A12 related to the brightness, the item A13 related to the contrast, and the item A14 related to the sharpness. In the item A11, any one of a setting value A111 for designating “dynamic,” a setting value A112 for designating “cinema,” and a setting value for designating “natural” can selectively be designated as the setting value. As described above, the third layer L3 includes candidates of the setting values which can be set to the items in the second layer L2. Further, in the case in which the setting value to be set to the item is a character string input by the user, it is also possible for the setting value itself to be included in the UI data 138.

The image processing section 125 disposes the large classification items 185 in the large classification item selection section 184 according to the UI data 138, and displays the setting target items 181 corresponding to the large classification item 185 selected in the large classification item selection section 184 in the item display section 182. It is also possible to previously designate the large classification item 185 which is selected by default when first displaying the menu screen 180. Further, the image processing section 125 displays the setting value currently set to the setting target item 181 or an initial value of the setting value in the setting value input section 183. The setting value of the setting target item 181 or the initial value of the setting value is included in the UI data 138.

As described above, the image processing section 125 displays the menu screen 180 based on the UI data 138. In other words, the display content of the menu screen 180 is defined by the UI data 138. For example, the image processing section 125 determines the number of the large classification items 185 displayed in the large classification item selection section 184, and the display positions or the indication sequence of the large classification items 185 in accordance with the UI data 138. Specifically, the large classification items included in the first layer L1 of the UI data 138 are disposed in the large classification item selection section 184. Further, the large classification items 185 are disposed in sequence beginning at the top in the large classification item selection section 184 in accordance with a description sequence of the large classification items in the UI data 138.

Further, for example, the image processing section 125 arranges the items of the second layer L2 associated with the large classification item in the UI data 138 in the item display section 182 as the setting target items 181. The arrangement sequence of the setting target items 181 accords with the description sequence of the items in the UI data 138. Therefore, in the case in which the content of the UI data has been rewritten, the image processing section 125 makes the projection section 110 project the menu screen 180 according to the UI data 138 thus rewritten. In the display system 1, by the projector 100 and the terminal device 10 performing communication with each other, the setting control section 134 (FIG. 2) performs rewriting of the UI data 138 of the projector 100. Thus, the configuration of the menu screen 180 can be edited.

### 4. Configuration of Terminal Device

FIG. 5 is a block diagram of the terminal device 10. The terminal device 10 is provided with a control section 10a for controlling each section of the terminal device 10. The control section 10a is constituted by a processor 20, a storage section 30 and so on. The storage section 30 is a storage device for storing a control program executed by the processor 20 and data in a nonvolatile manner, and is constituted by a semiconductor storage element or the like such as a flash ROM. The storage section 30 can also include a RAM constituting the work area for the processor 20. The processor 20 can be constituted by a single processor, or it is also possible to adopt a configuration in which a plurality of processors functions as the processor 20.

To the control section 10a, there are connected a wireless communication section 40, the touch panel 51, an operation detection section 55, and an NFC module 60. The touch panel 51 is provided with a display panel 52 and the touch sensor 53. The display panel 52 (a display section, a first display section) is formed of a liquid crystal display, an EL (electro luminescent) display or the like, and displays a variety of types of information in accordance with the control by the control section 10a.

The wireless communication section 40 is provided with an antenna, an RF circuit, and so on not shown, and performs the wireless data communication with an external device in accordance with the control by the control section 10a. The wireless communication section 40 is capable of performing the wireless communication such as wireless LAN or Bluetooth to thereby perform data communication with, for example, the wireless communication section 175 provided to the projector 100.

The operation detection section 55 (an input section, a first input section) is connected to the touch sensor 53 and a switch 54. The touch sensor 53 detects a contact operation to the touch panel 51 to output a position signal representing the operation position thus detected to the operation detection section 55. The operation detection section 55 generates coordinate information representing a coordinate on the touch panel 51 based on the position signal input from the touch sensor 53, and then outputs the coordinate information to the control section 10a.

The switch 54 is provided with operators such as switches provided to the terminal device main body 11 (FIG. 1), and outputs an operation signal to the operation detection section 55 in the case in which any of these operators are operated. The operation detection section 55 generates the operation information corresponding to the operators thus operated based on the operation signal input from the switch 54, and then outputs the operation information to the control section 10a. In the present embodiment, the touch sensor 53 and the switch 54 correspond to a terminal input section.

It is possible for the control section 10a to detect the contact operation to the touch panel 51 and the operation of each of the operators including the switches based on the coordinate information or the operation information input from the operation detection section 55.

The terminal device 10 is provided with the NFC module 60. The NFC module 60 is provided with the NFC tag 62 and the NFC reader 61. The NFC reader 61 is a reader/writer of the NFC tag provided with an antenna, a transmission circuit, a reception circuit and so on not shown. The NFC reader 61 performs communication with an external NFC tag having approached within a predetermined distance from the antenna to perform acquisition of data recorded on the NFC tag and writing of data to the NFC tag. The NFC reader 61 is capable of performing reading of the data from, and writing of the data to the NFC tag 162 of the projector 100.

The NFC tag 62 (a communication section, a storage section) has a rewritable storage area for storing data in a nonvolatile manner. Reading of data from the storage area of the NFC tag 62, and writing of data to the storage area of the NFC tag 62 can be performed by an external NFC reader/writer. Further, to the storage area of the NFC tag 62, it is possible to write data using the control section 10a or the NFC reader 61. The NFC tag 62 can be an active tag supplied with the power from a power supply circuit of the terminal device 10, or can also be a passive tag supplied with the power from an external device which reads the NFC tag 62.

The NFC reader 61 and the NFC tag 62 are housed inside the terminal device main body 11, and are fixed in the vicinity of a reverse surface to a surface on which the touch panel 51 is disposed. Therefore, by moving the reverse surface of the terminal device main body 11 closer to the marker 163 (FIG. 1), it becomes possible for the NFC reader 161 to communicate with the NFC tag 62 to perform reading of data from, and writing of data to the NFC tag 62. Further, it becomes possible for the NFC reader 61 to perform reading of data from, and writing of data to the NFC tag 162.

The processor 20 is constituted by an arithmetic processing device such as a CPU or a microcomputer. The processor 20 executes a control program 31 stored in the storage section 30 to thereby function as a display control section 21, a communication control section 22, a configuration information processing section 23 and an application execution section 24. By the processor 20 executing the control program 31, these functional blocks are realized due to the cooperation between software and hardware.

The storage section 30 stores an application program 32, UI configuration data 33 and content data 34 in addition to the control program 31. The application program 32 is a program to be executed by the processor 20. It is also possible for the storage section 30 to store a plurality of application programs 32, or it is also possible to adopt a configuration in which a plurality of functions is realized by a single application program 32. In the present embodiment, the application program 32 has a function of reproducing the content data 34 to transmit the image data from the terminal device 10 to the projector 100. The content data 34 is data of a content including the image data of a still image or a moving image, and can also include sound data.

The UI configuration data 33 is data related to the menu screen 180 to be projected by the projector 100, and corresponds to configuration information according to the invention. The UI configuration data 33 includes information for designating the setting items disposed on the menu screen 180 and the arrangement of the setting items so as to be associated with model information for identifying the model of the projector 100. The configuration of the UI configuration data 33 will be described later.

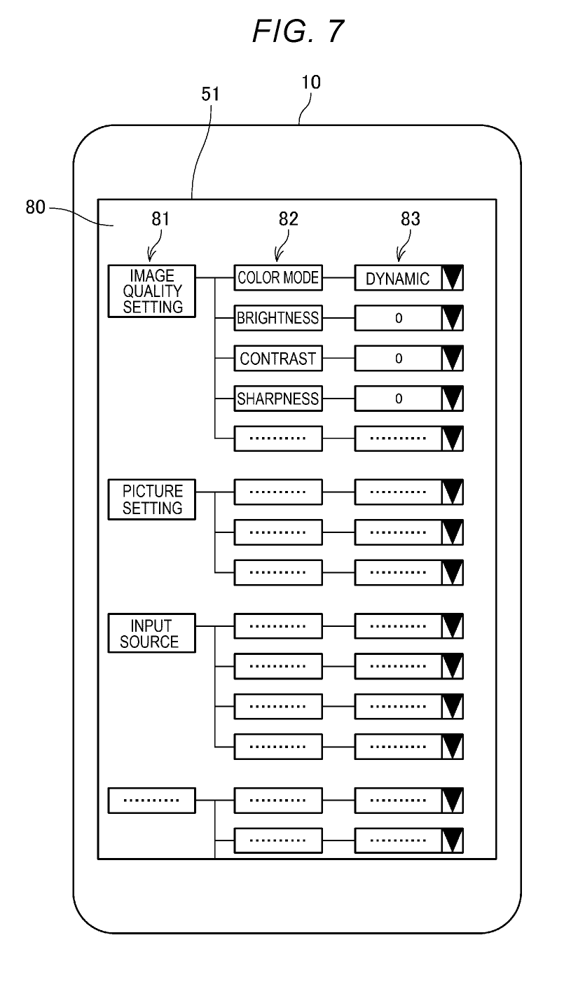

The display control section 21 controls the display of the image on the display panel 52 to display, for example, a setting screen 80 (FIG. 7) on the display panel 52 in accordance with a process of the configuration information processing section 23.

The communication control section 22 controls the wireless communication section 40 to perform the wireless communication with the projector 100.

The configuration information processing section 23 makes the display panel 52 display the setting screen 80 (FIG. 7) for editing the UI configuration data 33 in accordance with a trigger for starting editing. The configuration information processing section 23 edits the UI configuration data 33 in accordance with the operation performed on the setting screen 80, and then updates the UI configuration data 33. The configuration information processing section 23 stores the UI configuration data 33 thus updated in the NFC tag 62. Thus, it becomes possible for the projector 100 to read the UI configuration data 33 having been edited using the NFC reader 161.

The trigger for the configuration information processing section 23 to start editing the UI configuration data 33 includes an operation detected by the operation detection section 55, and writing to the NFC tag 62. Specifically, when the configuration information processing section 23 has detected the fact that the data has been written to the NFC tag 62 by the NFC reader 161, the configuration information processing section 23 starts a process of editing the UI configuration data 33 based on the data written in the NFC tag 62.

The application execution section 24 executes the application program 32 stored by the storage section 30. The storage section 30 is capable of storing a plurality of application programs 32. To each of the application programs 32, there is set a start-up condition. For example, in the case in which the operation detection section 55 has detected an operation for selecting an icon displayed on the display panel 52, the application execution section 24 executes the application program 32 associated with the icon thus operated.

### 5. Configuration of UI Configuration Data and Setting Screen

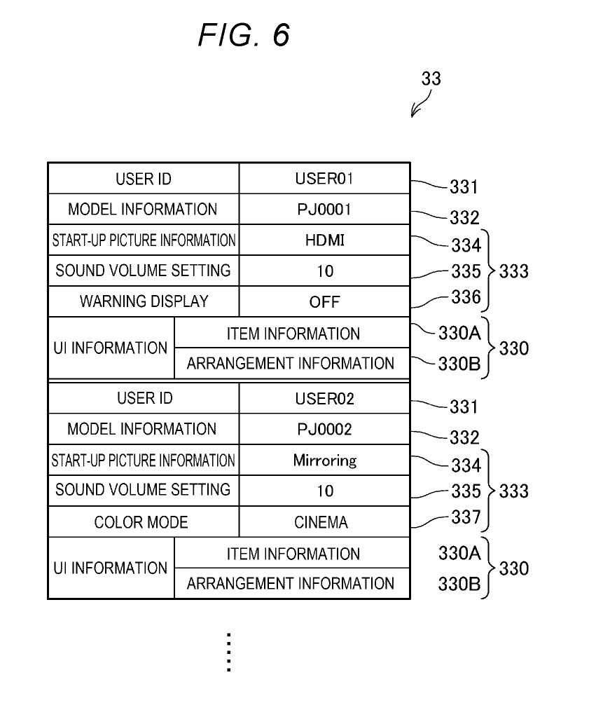

FIG. 6 is a diagram showing a configuration example of the UI configuration data 33 stored by the terminal device 10.

The UI configuration data 33 is data including a user ID 331, model information 332, operation setting information 333 and UI information 330 associated with each other. The UI configuration data 33 can also include a plurality of sets of the user ID 331, the model information 332, the operation setting information 333 and the UI information 330. In the example shown in FIG. 6, the UI configuration data 33 includes two sets of data, namely a set in which the model information 332 is “PJ0001,” and a set in which the model information 332 is “PJ0002.” It is obvious that three or more combinations can be included. Further, the user ID 331 corresponding to the same model information 332 can be common, or can also be different. The model information 332 corresponds to type information.

The user ID 331 is identification information for identifying the user using the terminal device 10. The model information 332 is identification information for identify the model of the projector 100, and can also include information for identifying a vendor as a manufacturer of the projector 100, or a model number of the projector 100 given by the vendor. The model information 332 is only required to be the information with which the type of the projector 100 can be identified, but is not required to individually identify the projector 100.

The operation setting information 333 included in the data in which the model information 332 is “PJ0001” includes setting values 334, 335 and 336 related to the operation of the projector 100. Specifically, there are included the setting value 334 of start-up picture information for designating an image source to be selected at the time of start-up of the projector 100, the setting value 335 of the volume of a sound output by the projector 100, and the setting value 336 designating availability of warning display.

The UI information 330 included in the data in which the model information 332 is “PJ0001” includes item information 330A for designating the items to be displayed in the menu screen 180 (FIG. 3) of the projector 100. Further, the UI information 330 includes arrangement information 330B for designating the sequence of the positions where the items are displayed in the menu screen 180. The item information 330A is the information for designating the setting target items 181 to be displayed in the item display section 182, the large classification items 185 to be displayed in the large classification item selection section 184, or both of the setting target items 181 and the large classification items 185 in the menu screen 180. For example, the item information 330A includes a setting value for designating whether to display the item in the menu screen 180 with respect to each of the setting target items 181 and the large classification items 185. The arrangement information 330B designates the indication sequence of the setting target items 181, the large classification items 185, or both of the setting target items 181 and the large classification items 185 designated to be displayed in the menu screen 180 by the item information 330A. For example, the arrangement information 330B includes a setting value for designating the display positions of the setting target items 181 in the item display section 182 in sequence beginning at the top. Further, for example, the arrangement information 330B designates the display positions of the large classification items 185 in the large classification item selection section 184 in sequence beginning at the top. Therefore, the configuration of the menu screen 180 is defined by the item information 330A and the arrangement information 330B.

Further, the operation setting information 333 included in the data in which the model information 332 is “PJ0002” includes the setting values 334, 335 and 337 related to the operation of the projector 100. The setting value 337 is a setting value for designating the color mode of the projector 100.

As described above, the UI configuration data 33 stores a variety of types of data including the UI information 330 for each of the models of the projector 100.

Further, the data to be written to the NFC tag 62 after the UI configuration data 33 is edited due to the control by the configuration information processing section 23 can be completely the same data as the UI configuration data 33 illustrated in FIG. 6. Further, it is also possible for the configuration information processing section 23 to write apart of the UI configuration data 33 stored by the storage section 30 into the NFC tag 62. On this occasion, the configuration information processing section 23 writes the data including at least the model information 332, and the UI information 330 associated with the model information 332 in the UI configuration data 33 out of the UI configuration data 33 into the NFC tag 62. Further, it is also possible to write the data including the user ID 331 associated with the model information 332 and the operation setting information 333.

FIG. 7 is a diagram showing a configuration example of the setting screen 80 as the user interface of the terminal device 10.

The setting screen 80 is displayed in the entire surface of the touch panel 51 provided to the terminal device 10, and it is possible to input the setting value by the user performing a touch operation on the setting screen 80.

The setting screen 80 has a hierarchical structure including a first layer setting section 81, a second layer setting section 82 and a third layer setting section 83.

The first layer setting section 81 corresponds to the first layer L1 of the UI data 138 of the projector 100. The second layer setting section 82 corresponds to the second layer L2, and the third layer setting section 83 corresponds to the third layer L3.

In the first layer setting section 81, the large classification items to be displayed in the menu screen 180 are arranged side by side. In the second layer setting section 82, the items included in each of the large classification items arranged in the first layer setting section 81 are arranged side by side. In the third layer setting section 83, there are arranged input boxes for selecting the setting values for the respective items arranged in the second layer setting section 82.

In the setting screen 80, whether to display the item in the menu screen 180 can be designated by the touch operation for each of the large classification items arranged in the first layer setting section 81. Further, by moving each of the large classification items in the first layer setting section 81 up and down, it is possible to change the indication sequence, namely the arrangement, of the large classification items in the menu screen 180.

Further, in the setting screen 80, whether to display the item in the menu screen 180 can be designated by the touch operation for each of the items arranged in the second layer setting section 82. Further, by moving each of the items in the second layer setting section 82 up and down, it is possible to change the indication sequence, namely the arrangement, of the items in the menu screen 180.

Further, in the setting screen 80, by the operation to the third layer setting section 83, it is possible to perform deletion and addition of selectable candidates as the setting value of each of the items arranged in the second layer setting section 82.

As the operation to the setting screen 80, a touch operation or a swipe operation can be used in the case in which the terminal device 10 is a device provided with the touch sensor 53 such as a smartphone or a tablet computer. Further, in the case in which an external pointing device such as a mouse or a pen tablet is connected to the terminal device 10, it is possible to perform the operation to the setting screen 80 using a tap operation, a click operation, a drag operation and so on by the pointing device.

The configuration information processing section 23 obtains the setting of display/non-display for each of the large classification items in the first layer setting section 81 and the items in the second layer setting section 82 in accordance with the operation to the setting screen 80 to edit the item information 330A. Further, the configuration information processing section 23 obtains the arrangement of the large classification items set to be displayed in the first layer setting section 81, and the arrangement of the items set to be displayed in the second layer setting section 82 in accordance with the operation to the setting screen 80 to edit the arrangement information 330B.

The items which can be set to the projector 100 differ by functions provided to the projector 100 or by specifications of the projector 100. For example, in the case in which the projector 100 is of a model not provided with a function of outputting a sound, the sound volume setting is unnecessary, and therefore, the large classification item and the items related to the sound volume setting are not included in the UI data 138. Therefore, it is necessary to provide the UI configuration data 33 associated with this model with a configuration in which the item information 330A and the arrangement information 330B do not include the data related to the items corresponding to the sound volume setting. Further, for example, in the case in which the projector 100 is of a model provided with a camera, the UI data 138 includes items for setting functions and operation conditions of the camera. Therefore, the setting screen 80 is required to be a user interface capable of setting whether to display the items for setting the functions and the operation conditions of the camera in the menu screen 180. The UI configuration data 33 edited using this setting screen 80 includes the UI information 330 corresponding to the items for setting the functions and the operation conditions of the camera.

Therefore, in the case of editing the UI configuration data 33, the terminal device 10 displays the setting screen 80 corresponding to the model of the projector 100 as the setting target.

### 6. Operation of Display System

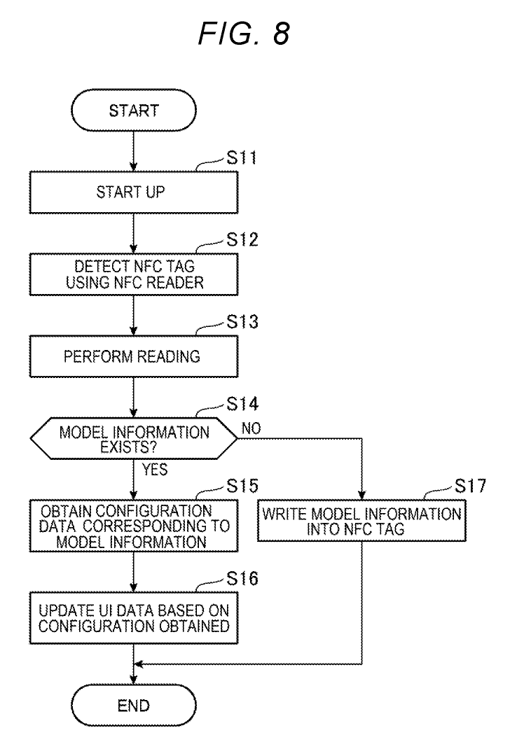

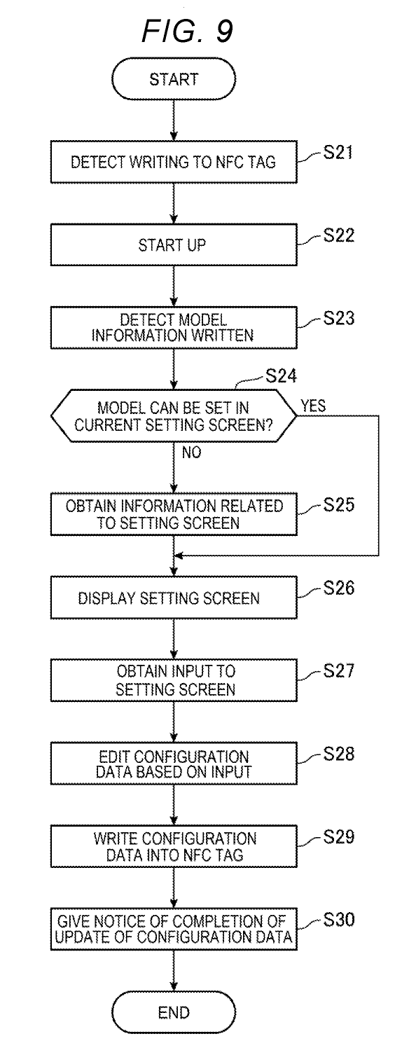

FIG. 8 is a flowchart showing an operation of the projector 100, and FIG. 9 is a flowchart showing an operation of the terminal device 10.

FIG. 8 and FIG. 9 show the operations in the case in which the user using the terminal device 10 operates the operation panel 172 to start up the projector 100, and then performs an operation of moving the terminal device 10 closer to the marker 163.

The control section 130 of the projector 100 starts up (step S11) each section of the projector 100 from a standby state in accordance with an operation of the operation panel 172 or the remote controller 70. Subsequently, the communication control section 133 starts (step S12) the detection of the NFC tag existing in a readable range using the NFC reader 161.

The communication control section 133 performs (step S13) reading of data from the NFC tag in the readable range of the NFC reader 161. In the step S13, the UI configuration data 33 is read by the NFC reader 161 from the NFC tag 62 having been moved closer to the marker 163 by the user.

The setting control section 134 determines (step S14) whether or not the model information 332 corresponding to the model of the projector 100 is included in the UI configuration data 33 having been read in the step S13 by the NFC reader 161. In the case in which the model information 332 corresponding thereto is included (YES in the step S14), the setting control section 134 obtains the setting data associated with the model information 332 (step S15). The setting data obtained in the step S15 includes at least the UI information 330, and can also include the operation setting information 333.

The setting control section 134 updates (step S16) the UI data 138 based on the UI information 330 included in the setting data obtained in the step S15. Thus, it is possible for the setting control section 134 to project the menu screen 180 having a configuration corresponding to the UI configuration data 33 of the terminal device 10.

Further, in the case in which the model information 332 corresponding to the projector 100 is not included in the UI configuration data 33 read from the NFC tag 62 (NO in the step S14), the setting control section 134 writes (step S17) the model information of the projector 100 into the NFC tag 62. Specifically, it is the case in which none of the model information 332 included in the UI configuration data 33 read in the step S13 corresponds to the model of the projector 100. In this case, the setting control section 134 performs writing of the data to the NFC tag 62 using the NFC reader 161. The data written into the NFC tag 62 in the step S17 corresponds to request data according to the invention. The data includes the model information of the projector 100. Further, it is also possible to include a command for requesting the UI configuration data 33 corresponding to the projector 100.

When the user holds the terminal device 10 over the marker 163, it is possible for the terminal device 10 to be set in a waiting state called a sleep state or a standby state. In this state, the terminal device 10 is capable of detecting the writing to the NFC tag 62 using the communication control section 22.

As shown in FIG. 9, when the terminal device 10 detects (step S21) the writing to the NFC tag 62 using the communication control section 22, the terminal device 10 starts up (step S22) from the waiting state to detect (step S23) the information written into the NFC tag 62. In the present embodiment, the information is the model information written by the setting control section 134 in the step S17 (FIG. 8).

The configuration information processing section 23 determines (step S24) whether or not the model represented by the model information detected in the step S23 is the model corresponding to the setting screen 80 which can be displayed in the terminal device 10. In the case in which it has been determined that this model is not the model corresponding to the setting screen 80 (NO in the step S24), the configuration information processing section 23 obtains (step S25) the information for displaying the setting screen 80 corresponding to this model using the wireless communication section 40 or the like. For example, the configuration information processing section 23 accesses a server (not shown) connected to a communication network via a wireless communication line to obtain the information for configuring the setting screen 80 corresponding to the model information written into the NFC tag 62 using the wireless communication section 40. The information obtained here corresponds to the large classification items disposed in the first layer setting section 81 of the setting screen 80, the items disposed in the second layer setting section 82, candidates of the setting values which can be set so as to correspond to the respective items, and so on. The configuration information processing section 23 displays (step S26) the setting screen 80 based on the information obtained in the step S25.

Further, in the case in which it has been determined that this model is the model corresponding to the setting screen (YES in the step S24), the configuration information processing section 23 displays (step S26) the setting screen 80.

The configuration information processing section 23 detects an input operation to the setting screen 80 to obtain (step S27) an input content. The configuration information processing section 23 edits (step S28) the UI configuration data 33 stored by the storage section 30 based on the input content thus obtained, and then writes (step S29) the UI configuration data 33 having been edited into the NFC tag 62. Further, the configuration information processing section 23 notifies (step S30) the projector 100 of the update of the UI configuration data 33 using the data written into the NFC tag 62 or the wireless communication section 40.

As described hereinabove, the display system 1 according to the embodiment to which the invention is applied is provided with the terminal device 10 and the projector 100.

The terminal device 10 is provided with the display panel 52, the operation detection section 55 for receiving the input, and the wireless communication section 40 or the NFC module 60 each as the communication section for communicating with the projector 100. Further, the terminal device 10 is provided with the configuration information processing section 23 for identifying the type of the projector 100 with which the communication is made by the communication section. The configuration information processing section 23 makes the display panel 52 display the setting screen 80 as the user interface for performing setting of the projector 100 in accordance with the type of the projector 100 thus identified. In the case in which the configuration information processing section 23 receives the input corresponding to the user interface using the input section, the configuration information processing section 23 edits the UI configuration data 33 related to the setting of the projector 100 based on the input thus received. The terminal device 10 is provided with the NFC tag 62 in which the UI configuration data 33 having been edited by the configuration information processing section 23 is stored so as to be able to be read by the projector 100.

The projector 100 is provided with the projection section 110, the input processing section 171 for receiving the input, and the NFC reader 161 for obtaining the UI configuration data 33 for defining the configuration of the user interface from the NFC tag 62 as an external recording medium. The projector 100 is provided with the setting control section 134 for making the projection section 110 display the menu screen 180 as the user interface in which the setting target items are disposed. The setting control section 134 determines the setting values to the setting target items based on the input received by the input processing section 171, and then sets the functions of the projector 100 in accordance with the setting values thus determined. The setting control section 134 configures the menu screen 180 in accordance with the UI configuration data 33 obtained by the acquisition section, and then makes the projection section 110 display the menu screen 180.

According to the terminal device 10 to which the electronic apparatus and the control method of the electronic apparatus according to the invention are applied, the terminal device 10 displays the setting screen 80 in accordance with the type of the projector 100. The terminal device 10 is capable of editing the UI configuration data 33 related to the setting of the projector 100 using the setting screen 80. Thus, it is possible to simplify the operation of editing the UI configuration data 33 in accordance with the model of the projector 100 to thereby reduce the burden on the user.

Subject to the fact that the model information has been written into the NFC tag 62 as the request data for requesting the UI configuration data 33 with the type of the projector 100 designated, the configuration information processing section 23 makes the setting screen 80 corresponding to the type of the projector 100 thus designated be displayed. The fact that the model information is written into the NFC tag 62 corresponds to reception of the request data.

Thus, since the terminal device 10 displays the setting screen 80 based on the model information written by the projector 100, it is possible to simplify the operation for displaying the setting screen 80 corresponding to the type of the projector 100.

Further, the UI configuration data 33 includes the model information 332 representing the type of the projector 100, the UI information 330 as the information related to the setting of the projector 100 and so on associated with each other. Thus, since the type of the projector 100 and the setting of the projector 100 are associated with each other in the UI configuration data 33, it is possible to reduce the burden required for the management of the UI configuration data 33.

Further, the UI configuration data 33 includes the information for designating the setting target items to be displayed and the information for designating the arrangement of the setting target items regarding the menu screen 180 to be displayed by the projector 100 for the setting related to the operation of the projector 100. Thus, it is possible to set the setting target items and the arrangement thereof to be displayed in the menu screen 180 with a simple operation using the terminal device 10 making the communication with the projector 100.

Further, according to the projector 100 to which the display device and the control method of the display device according to the invention are applied, the menu screen 180 as the user interface of the projector 100 can be configured in accordance with the UI configuration data 33 obtained from the NFC tag 62. Therefore, it is possible to easily perform the setting related to the user interface of the projector 100 using the terminal device 10 which provides the UI configuration data 33 recorded on the NFC tag 62.

Further, in the case in which the UI configuration data 33 corresponding to the type of the projector 100 has not been recorded on the NFC tag 62, the projector 100 transmits the request data. Specifically, the projector 100 writes the model information to the terminal device 10 as the request data for requesting the UI configuration data 33 with the type of the projector 100 designated using the NFC reader 161. The writing corresponds to transmission of the request data. Thus, it is possible for the projector 100 to request the UI configuration data 33 corresponding to the type of the projector 100 to the terminal device 10. Therefore, it is not necessary for the projector 100 to manage the correspondence between the type of the projector 100 and the UI configuration data 33, and it is possible to reduce the burden related to the management.

Further, according to the display system. 1, the menu screen 180 as the user interface of the projector 100 can be configured in accordance with the UI configuration data 33 which is stored in the NFC tag 62 by the terminal device 10. Therefore, the setting related to the user interface of the projector 100 can easily be achieved using the terminal device 10. Further, the terminal device 10 displays the setting screen 80 as the user interface so as to correspond to the type of the projector 100. In the terminal device 10, the UI configuration data 33 related to the setting of the projector 100 can be edited using the setting screen 80. Therefore, it is possible to simplify the operation of editing the UI configuration data 33 in accordance with the model of the projector 100 to thereby reduce the burden on the user.

### 7. Other Embodiments

The embodiment described above shows a specific example to which the invention is applied, and the invention is not limited to the embodiment.

For example, in the embodiment described above, there is described the example of using the NFC module 60 as the communication section. In this example, as the operation of transmitting the request data, the projector 100 performs the operation of writing the model information into the NFC tag 62. Further, the terminal device 10 performs the operation assuming the fact that the model information has been written into the NFC tag 62 as the fact that “the request data has been transmitted.” The invention is not limited to this example, but it is also possible for the projector 100 to transmit the request data with the wireless communication section 175. Specifically, the projector 100 wirelessly transmits the request data with the wireless communication section 175 in the case in which the UI configuration data 33 read from the NFC tag 62 does not correspond to the projector 100 (NO in the step S14). In this case, it is sufficient for the terminal device 10 to receive the request data transmitted by the projector 100 using the wireless communication section 40 in the step S21.

Further, it is also possible for the projector 100 to write a command as the request data into the NFC tag 62 in the step S17. The command is written into the NFC tag 62 together with the model information, or instead of the model information. In this case, it is sufficient for the terminal device 10 to analyze the command and then determine whether or not the setting screen 80 can deal with the model of the projector 100 thus requested in the step S24.

Further, in the configuration in which the projector 100 and the terminal device 10 perform the communication using the NFC tag 62, it is not required for the projector 100 to be provided with the NFC tag 162. Further, it is also possible for the terminal device 10 and the projector 100 to perform the wireless communication using the wireless communication section 40 and the wireless communication section 175 in parallel with the process that the projector 100 reads the NFC tag 62.

Further, the display device according to the invention is not limited to the projector 100, but it is also possible to adopt a liquid crystal monitor or a liquid crystal television set for displaying an image on a liquid crystal display panel as the display device. It is also possible to use the display device provided with a plasma display panel, or an organic EL display panel such as OLED (organic light-emitting diode) or an OEL (organic electro luminescence) display.

Further, each of the functional sections shown in FIG. 2 and FIG. 5 is for showing the functional configuration, and the specific implementation configuration is not particularly limited. In other words, it is not necessarily required to install the hardware corresponding individually to each of the functional sections, but it is obviously possible to adopt the configuration of realizing the functions of the plurality of functional sections by a single processor executing a program. Further, apart of the function realized by software in the embodiment described above can also be realized by hardware, or a part of the function realized by hardware can also be realized by software. Besides the above, the specific detailed configuration of each of the other sections of the terminal device 10 and the projector 100 constituting the display system 1 can arbitrarily be modified within the scope or the spirit of the invention.

What is claimed is:

1. An electronic apparatus comprising:
a display section;
an input section adapted to receive an input;
a communication section adapted to communicate with a display device;
a configuration information processing section adapted to identify a type of the display device, make the display section display a user interface used to perform setting of the display device in accordance with the identified type of the display device, and edit configuration information related to the setting of the display device based on the input received in a case in which the input corresponding to the user interface is received by the input section; and
a storage section adapted to store the configuration information edited by the configuration information processing section so as to be able to be read by the display device.

2. The electronic apparatus according to claim 1, wherein
subject to reception by the communication section of request data requesting the configuration information with the type of the display device designated, the configuration information processing section makes the display section display the user interface corresponding to the type of the display device designated by the request data.

3. The electronic apparatus according to claim 1, wherein
the configuration information includes type information representing the type of the display device and information related to the setting of the display device associated with each other.

4. The electronic apparatus according to claim 1, wherein
the configuration information includes information for designating setting target items to be displayed and information for designating an arrangement of each of the setting target items with respect to the user interface to be displayed by the display device for setting related to an operation of the display device.

5. A display device equipped with a display section, comprising:
an input section adapted to receive an input;
a setting control section adapted to make the display section display a user interface having setting target items arranged, determine a setting value to each of the setting target items based on the input received by the input section, and then set a function of the display device in accordance with the setting value determined; and
an acquisition section adapted to obtain configuration information defining a configuration of the user interface from an external recording medium,
wherein the setting control section configures the user interface in accordance with the configuration information obtained by the acquisition section, and then makes the display section display the user interface.

6. The display device according to claim 5, wherein
the acquisition section transmits request data requesting the configuration information with a type of the display device designated to an electronic apparatus corresponding to the external recording medium in a case in which the configuration information corresponding to the type of the display device is absent in the external recording medium.

7. A method of controlling an electronic apparatus, comprising:
communicating with a display device using a communication section;
identifying a type of the display device to be communicated with;
displaying a user interface used to perform setting of the display device in accordance with the identified type of the display device;
receiving an input corresponding to the user interface;
editing configuration information related to the setting of the display device based on the input received; and
storing the edited configuration information so as to be able to be read by the display device.
